(19) United States
(12) Patent Application Publication
(10) Pub. No.: US 2015/0154917 A1
(43) Pub. Date: Jun. 4, 2015

(54) BACKLIGHT MODULE, METHOD FOR DRIVING SAME AND DISPLAY DEVICE USING SAME

(71) Applicant: Seoul Semiconductor Co., Ltd., Ansan-si, Gyeonggi-do (KR)

(72) Inventors: Hye Man Jung, Ansan-si (KR); Oh Sug Kim, Ansan-si (KR); Hyun Gu Kang, Ansan-si (KR); II Kyung Suh, Ansan-si (KR); Young Eun Yang, Ansan-si (KR)

(73) Assignee: Seoul Semiconductor Co., Ltd., Ansan-si, Gyeonggi-do (KR)

(21) Appl. No.: 14/367,227

(22) PCT Filed: Dec. 21, 2012
(86) PCT No.: PCT/KR2012/011289

§ 371 Date: Oct. 8, 2014

(30) Foreign Application Priority Data
Dec. 21, 2011 (KR) 10-2011-0139226
Dec. 21, 2012 (KR) 10-2012-0150621

(51) Int. Cl. G09G 3/34; G09G 3/36

(52) U.S. Cl. CPC G09G 3/3406; G09G 3/3696; G09G 2330/021; G09G 2360/08

(57) ABSTRACT

A display device includes a power rectifying unit for rectifying alternating power, a power factor correction unit correcting the power factor of the alternating power and outputting a power factor corrected voltage containing a direct current voltage component having at least a predetermined size, a display module driven by the power factor corrected voltage, a backlight unit, and a driving unit supplying the main driving voltage to a backlight unit, receiving the power factor corrected voltage when the size of the rectified voltage is smaller than a preset threshold value to generate a supplementary driving voltage.

### CROSS-REFERENCE TO RELATED APPLICATIONS

This application is the National Stage Entry of International Application PCT/KR2012/011289, filed on Dec. 21, 2012, and claims priority from and the benefit of Korean Patent Application No. 10-2011-0139226, filed on Dec. 21, 2011, and Korean Patent Application No. 10-2012-0150621, filed on Dec. 21, 2012, all of which are incorporated herein by reference for all purposes as if fully set for herein.

### BACKGROUND

1. Field

Embodiments of the present invention relate to a backlight module, a method for driving the same, and a display device using the same. More particularly, embodiments of the present invention relate to a backlight module that can efficiently drive a plurality of light emitting diodes in a backlight unit using a rectified voltage having a ripple waveform and a power factor-corrected voltage having a DC component of a predetermined magnitude or more, a method for driving the same, and a display device using the same.

2. Discussion of the Background

Recently, flat panel displays have been used for broad ranges of applications from mobile devices requiring small size and low power consumption to large digital TVs requiring reductions in weight and thickness. In particular, a liquid crystal display is the most widely used flat panel display and requires a light source referred to as a backlight unit (BLU) at a rear side of a liquid crystal panel because the liquid crystal panel is not self-emissive.

Since light generated in a backlight unit is emitted through a liquid crystal layer and color filters, the backlight unit provides substantial influence on performance of the liquid crystal display (LCD). For example, the backlight unit provides substantial influence not only on screen quality of the liquid crystal display but also on the weight, design, lifespan, and power consumption of the liquid crystal display.

Recent backlight modules are generally composed of a backlight unit including a plurality of light emitting diodes (LED) and a backlight unit driver for driving the backlight unit. The performance of the backlight unit is thus determined according to the method used for driving the LED backlight units.

A backlight module used for a typical liquid crystal display drives the plurality of LEDs using DC power. To this end, the liquid crystal display requires a separate converter circuit for generating DC power for LED driving.

As such, since a typical liquid crystal display requires a separate converter for driving the backlight module in addition to a converter for driving a display module, high power consumption becomes a problem and causes deterioration in operation efficiency due to the increased power consumption of the converters.

### SUMMARY

Embodiments of the present invention provide a backlight module, a method of driving the same, and a display device using the same, which can achieve efficient driving of a plurality of light emitting diodes in a backlight unit using a rectified voltage having a ripple waveform and a power factor-corrected voltage having a DC component of a predetermined magnitude or more by removing a DC-DC converter for supplying drive power to the backlight module.

Embodiments of the present invention provide a backlight module, a method of driving the same, and a display device using the same, which provide stable driving of devices while improving reliability of the devices by removing a non-light emitting section upon multi-stage driving of an LED backlight unit using a rectified voltage having a ripple waveform and a power factor-corrected voltage having a DC component of a predetermined magnitude or more, while compensating for lack of energy upon increase in current level in response to dimming signals with a supplementary drive current based on the power factor-corrected voltage.

Embodiments of the present invention provide a backlight module, a method of driving the same, and a display device using the same, which can reduce manufacturing costs of the display device by removing a DC-DC converter, which supplies power for driving an LED backlight unit of a liquid crystal display.

In accordance with one aspect of the present invention, a display device includes: a power rectification unit rectifying alternating power to output a rectified voltage; a power factor correction unit receiving the rectified voltage from the power rectification unit and correcting a power factor of the alternating power to output a power factor-corrected voltage including a direct voltage component having at least a predetermined magnitude; a display module driven by the power factor-corrected voltage; a backlight unit including a plurality of light emitting diodes for providing backlight illumination to the display module; and a backlight unit driver generating a main drive voltage or a main drive current and supplying the main drive voltage or the main drive current to the backlight unit by receiving the rectified voltage, and generating a supplementary drive voltage or a supplementary drive current and supplying the supplementary drive voltage or the supplementary drive current to the backlight unit by receiving the power factor-corrected voltage when the rectified voltage is less than a preset critical value.

In the display device according to one embodiment of the invention, the backlight unit driver may supply the supplementary drive voltage or the supplementary drive current to the backlight unit, when a main drive voltage based on the rectified voltage is less than a minimum voltage for driving at least one light emitting diode.

In the display device according to another embodiment of the invention, the display module may generate a dimming signal to control the backlight unit driver to generate a preset dimming voltage or a preset dimming current. Here, in response to the dimming signal, the backlight unit driver may supply the supplementary drive voltage to the backlight unit when the main drive voltage is less than the preset dimming voltage, or may supply the supplementary drive current to the backlight unit when the main drive current is less than the preset dimming current.

According to a further embodiment of the invention, the display device further includes a first interconnection line connecting an output terminal of the power rectification unit to a first input terminal of the backlight unit driver and transferring the rectified voltage from the power rectification unit to the backlight unit driver; and a second interconnection line connecting an output terminal of the power factor correction unit to a second input terminal of the backlight unit driver and transferring the power factor-corrected voltage from the power factor correction unit to the backlight unit driver.

In the display device according to yet another embodiment of the invention, the backlight unit driver may control the backlight unit based on the rectified voltage, the magnitude of which periodically varies over time, such that the number of light emitting diodes emitting light among the plurality of light emitting diodes increases as the rectified voltage increases, and such that the number of light emitting diodes emitting light among the plurality of light emitting diodes decreases as the rectified voltage decreases.

In the display device according to yet another embodiment of the invention, the backlight unit driver may include a plurality of current controllers each connected between reference potential and an output terminal of each of a plurality of LED groups each including at least one light emitting diode among the plurality of light emitting diodes, and forming a current path between the reference potential and the output terminal of each of the LED groups; and a control signal generator applying a control signal to the plurality of current controllers to control operation of the plurality of current controllers depending upon the magnitude of the main drive voltage.

In the display device according to yet another embodiment of the invention, the backlight unit driver may further include a voltage correction unit disposed between an output terminal of the power factor correction unit and an input terminal of the backlight unit to regulate supply of the power factor-corrected voltage to the backlight unit.

In the display device according to yet another embodiment of the invention, the voltage correction unit may include: a switching device having a first terminal connected to the output terminal of the power factor correction unit; and a diode including an anode connected to a second terminal of the switching device and a cathode connected to the input terminal of the backlight unit. Here, the switching device is turned on/off in response to the control signal from the control signal generator.

In the display device according to yet another embodiment of the invention, the backlight unit driver may apply the control signal to the voltage correction unit to supply the supplementary drive voltage or the supplementary drive current based on the power factor-corrected voltage to the plurality of LED groups, when the rectified voltage is less than a minimum voltage for driving at least one LED group among the plurality of LED groups.

In the display device according to yet another embodiment of the invention, in response to a dimming signal from the display module to control the backlight unit driver to generate a preset dimming voltage or a preset dimming current, the backlight unit driver may supply the supplementary drive voltage to the backlight unit when the main drive voltage is less than the preset dimming voltage, or supply the supplementary drive current to the backlight unit when the main drive current is less than the preset dimming current.

In the display device according to yet another embodiment of the invention, the power rectification unit may include a first power rectifier provided to an input terminal of the power factor correction unit and supplying the rectified voltage obtained by rectifying the alternating power to the power factor correction unit; and a second power rectifier provided to the backlight unit driver and supplying the rectified voltage obtained by rectifying the alternating power to the backlight unit.

In the display device according to yet another embodiment of the invention, the power factor correction unit may include: an inductor including a first terminal connected to a high potential side first terminal of an input capacitor connected in series to an output terminal of the power rectification unit; a switch including a first terminal connected to a second terminal of the inductor and a second terminal connected to a low potential side second terminal of the input capacitor; a diode including an anode commonly connected to the second terminal of the inductor and the first terminal of the switch and a cathode connected to a high potential side first terminal of an output capacitor; and the output capacitor having the first terminal connected to the cathode of the diode and a second terminal commonly connected to the low potential side second terminal of the input capacitor and the second terminal of the switch.

In the display device according to yet another embodiment of the invention, the power factor correction unit may have an interleaved boost converter structure in which two power factor correction units each including the inductor, the switch, the diode and the output capacitor are connected in parallel to each other.

In the display device according to yet another embodiment of the invention, at least one of the power rectification unit and the power factor correction unit may be arranged in the form of a single integrated circuit with the backlight unit driver.

In accordance with another aspect of the present invention, a backlight module includes: a power factor correction unit correcting a power factor of alternating power to output power factor-rectified power; a backlight unit including a plurality of light emitting diodes; and a backlight unit driver driving the plurality of light emitting diodes in response to a dimming signal. Here, the backlight unit driver selectively supplies the alternating power and the power factor-rectified power to the plurality of light emitting diodes according to the dimming signal and a magnitude of the alternating power.

In the backlight module according to one embodiment of the invention, the backlight unit may include the plurality of light emitting diodes connected in series to each other, and the backlight unit driver may include a power rectification unit rectifying alternating power to supply a rectified voltage to the backlight unit; a plurality of current controllers each connected between reference potential and one side terminal (cathode) of each of the light emitting diodes and forming a current path between the reference potential and the light emitting diode; and a control signal generator generating a control signal to control operation of the plurality of current controllers according to the dimming signal and a magnitude of the rectified voltage.

In the backlight module according to one embodiment of the invention, the control signal generator may regulate electric current flowing through the backlight unit by controlling operation of the current controllers depending upon a level of the dimming signal.

The backlight module according to another embodiment of the invention may further include a voltage correction unit supplying a voltage output from the power factor correction unit to the backlight unit depending upon a magnitude of the rectified voltage and a level of the dimming signal.

In the backlight module according to a further embodiment of the invention, the voltage correction unit may supply the voltage output from the power factor correction unit to the backlight unit during a section in which the rectified voltage is less than or equal to a critical value.

In the backlight module according to a further embodiment of the invention, the voltage correction unit may include a switching device performing a switching operation in response to a correction control signal generated based on the dimming signal during a section in which the rectified voltage is less than or equal to a critical value. Here, the switching device may connect an output terminal of the power factor correction unit to the backlight unit in response to the correction control signal.

In the backlight module according to yet another embodiment of the invention, the voltage correction unit may further include a diode having an anode connected in series to one side terminal of the switching device. Here, the other side terminal of the switching device may be connected to the output terminal of the power factor correction unit, and a cathode of the diode may be connected to a node to which an input terminal of the backlight unit and the power rectification unit are connected.

In accordance with a further aspect of the present invention, a method of driving a backlight module is provided. In the method, the backlight module is driven by a backlight unit driver, which drives a backlight unit including a plurality of LED groups each including at least one light emitting diode to provide illumination to a display module. The method includes: rectifying alternating power to generate a rectified voltage; correcting a power factor of the alternating power to generate a power factor-corrected voltage including a direct voltage component having at least a predetermined magnitude; receiving the rectified voltage to generate a main drive voltage or a main drive current and supplying the main drive voltage or the main drive current to the backlight unit; and supplying a supplementary drive voltage or a supplementary drive current based on the power factor-corrected voltage to the backlight unit when the rectified voltage is less than a preset critical value.

In the method according to one embodiment of the invention, the step of receiving the rectified voltage may include controlling the backlight unit based on the rectified voltage, the magnitude of which periodically varies over time, such that the number of LED groups emitting light among the plurality of LED groups increases as the rectified voltage increases, and such that the number of LED groups emitting light among the plurality of LED groups decreases as the rectified voltage decreases.

In the method according to another embodiment of the invention, the step of supplying the supplementary drive voltage or the supplementary drive current may include supplying the supplementary drive voltage or the supplementary drive current based on the power factor-corrected voltage to the plurality of LED groups, when the rectified voltage is less than a minimum voltage for driving at least one LED group among the plurality of LED groups.

The method according to a further embodiment of the invention may further include receiving a dimming signal from the display module to control the backlight unit driver to generate a preset dimming voltage or a preset dimming current, before supplying the supplementary drive voltage or the supplementary drive current. Here, supply of the supplementary drive voltage or the supplementary drive current may include supplying the supplementary drive voltage to the backlight unit when the main drive voltage is less than the preset dimming voltage, or supplying the supplementary drive current to the backlight unit when the main drive current is less than the preset dimming current.

With the configuration as described above, the backlight module, the method of driving the backlight module and the display device using the backlight module according to the present invention can achieve efficient driving of a plurality of LEDs in a backlight unit using a rectified voltage having a ripple waveform and a power factor-corrected voltage having a DC component of a predetermined magnitude or more by removing a DC-DC converter for supplying drive power to the backlight module.

The method and the display device according to some embodiments of the present invention can secure stable driving of devices while improving reliability of the devices by removing a non-light emitting section upon multi-stage driving of an LED backlight unit using a rectified voltage having a ripple waveform and a power factor-corrected voltage having a DC component of a predetermined magnitude or more, while compensating for lack of energy upon increase in current level in response to dimming signals with a supplementary drive current based on the power factor-corrected voltage.

The method and the display device according to some embodiments of the present invention can reduce manufacturing costs of the display device by removing a DC-DC converter, which supplies power for driving an LED backlight unit of a liquid crystal display.

### BRIEF DESCRIPTION OF THE DRAWINGS

FIG. 1 is a schematic block diagram of a display device according to the present invention.

FIG. 2 is a circuit diagram of an AC-DC converter applicable to the display device shown in FIG. 1.

FIG. 3 is a block diagram of a backlight module applicable to the display device shown in FIG. 1.

FIG. 4 is a waveform graph depicting an operating principle of the backlight module in the display device shown in FIG. 1.

FIG. 5 and FIG. 6 are waveform graphs depicting an illumination principle applicable to the display device shown in FIG. 1.

FIG. 7 is a schematic block diagram of a display device according to one embodiment of the present invention.

FIG. 8 is a circuit diagram of an AC-DC converter applicable to the display device shown in FIG. 7.

FIG. 9 is a block diagram of a power supply for a display device according to a further embodiment of the present invention.

FIG. 10 is a block diagram of a backlight module applicable to the display device shown in FIG. 9.

FIG. 11 is a waveform graph depicting an operating principle of the display device shown in FIG. 9.

FIG. 12 is a flowchart of a method of driving a backlight module according to the present invention.

### DETAILED DESCRIPTION OF THE ILLUSTRATED EMBODIMENTS

Terms and words used in the following description and claims should be interpreted as having a meaning that is consistent with their meaning in the context of the specification and relevant art and should not be interpreted in an idealized or overly formal sense as defined in commonly used dictionaries. In addition, the disclosure in the specification and the configurations shown in the drawings are just exemplary embodiments of the present invention and do not cover all the technical ideas of the present invention. Thus, it should be understood that such embodiments may be replaced by various equivalents and modifications at the time when the present application is filed.

Terms used in the specification are merely used to illustrate certain embodiments and do not limit the present invention. As used in this specification, the singular forms “a”, “an” and “the” are intended to include the plural forms as well, unless context clearly indicates otherwise.

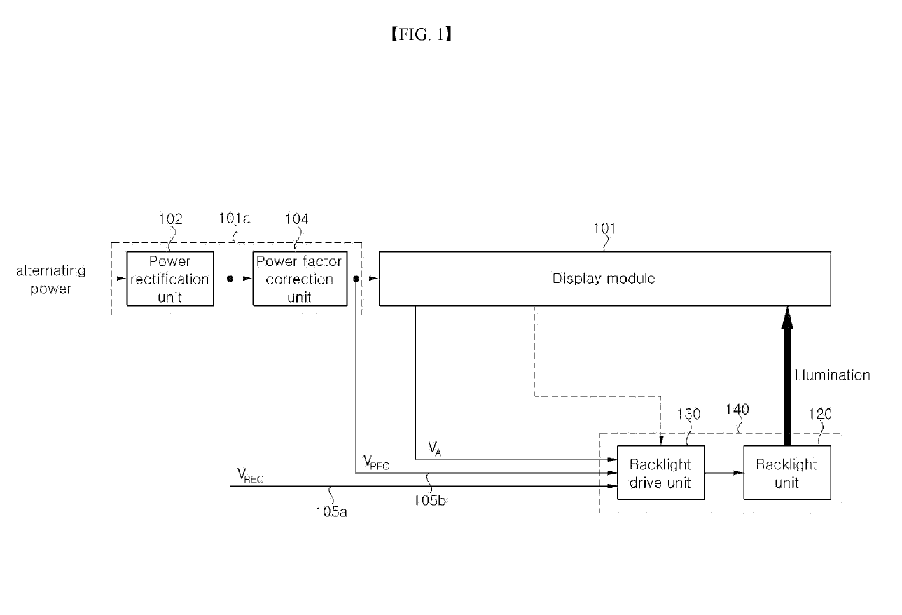

FIG. 1 is a schematic block diagram of a display device according to the present invention.

Referring to FIG. 1, a display device according to the present invention includes a display module 101, a power rectification unit 102, a power factor correction unit 104, a backlight unit 120, and a backlight unit driver 130. The power rectification unit 102 and the power factor correction unit 104 correspond to an AC-DC converter 101a provided to an input terminal of the display device and converting alternating power into DC power. In addition, the backlight unit 120 and the backlight unit driver 130 correspond to a backlight module supplying illumination to a screen display unit of the display module 101.

In the display device according to this embodiment, the backlight module 140 receives rectified power including a rectified voltage V_{REC} and power factor-rectified power including a power factor-corrected voltage V_{PFC} from the AC-DC converter 101a, and removes a non-light emitting section from the multi-stage drive type backlight unit 120 using the rectified power and the power factor-rectified power.

In this exemplary embodiment, the rectified power including the rectified voltage V_{REC} may be supplied from the power rectification unit 102 to the backlight unit driver 130 through a first interconnection line 105a, which connects an output terminal of the power rectification unit 102 to a first input terminal of the backlight unit driver 130. In addition, the power factor-rectified power including the power factor-corrected voltage V_{PFC} may be supplied from the power factor correction unit 104 to the backlight unit driver 130 through a second interconnection line 105b, which connects an output terminal of the power factor correction unit 104 to a second input terminal of the backlight unit driver 130. The first interconnection line 105a and the second interconnection line 105b may be realized by power cables, conductive patterns of an integrated device, and the like.

Namely, when driving the backlight unit 120 including a plurality of LED groups by multi-stage driving, the backlight module 140 according to the present exemplary embodiment removes a non-light emitting section, which occurs in multi-stage driving, using the power factor-corrected voltage. Herein, the term multi-stage driving refers to an operation of controlling the backlight unit 120 such that the number of LED groups emitting light in the backlight unit 120 increases as a drive voltage (corresponding to the rectified voltage) of the backlight unit 120 increases, or such that the number of LED groups emitting light in the backlight unit 120 decreases as the drive voltage decreases. In this way, the backlight module 140 according to the present invention can prevent the backlight unit 120 from flickering or suffering brightness fluctuation visible to a user upon driving of the backlight unit by removing the non-light emitting section which occurs upon driving of the existing multi-stage driving type backlight unit.

The backlight module 140 may be realized to receive a predetermined voltage Va or a predetermined signal for driving and controlling the backlight module from the display module 101 connected to the display device via a certain user interface.

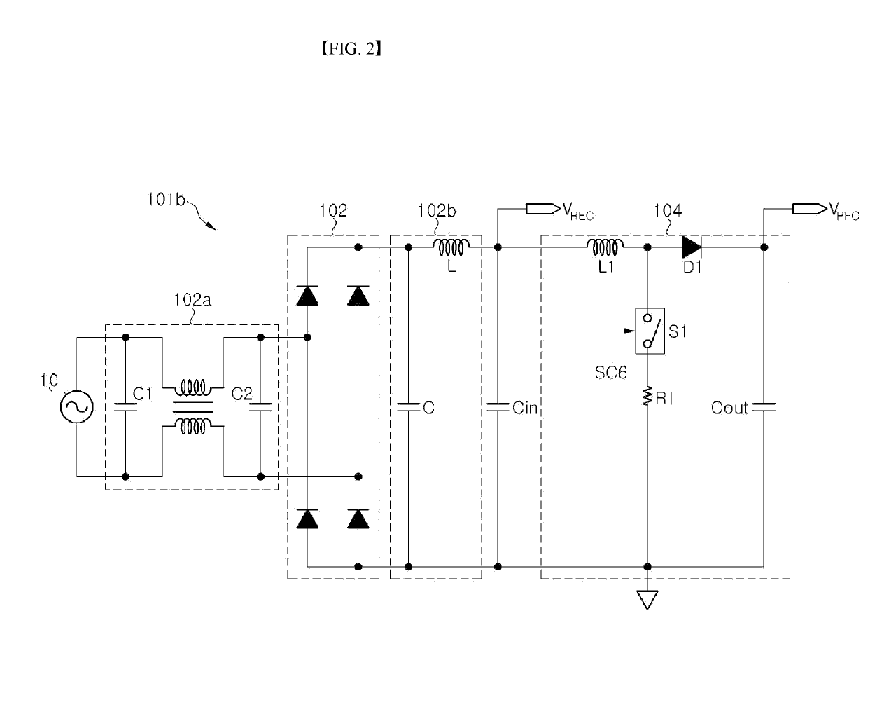

FIG. 2 is a circuit diagram of an AC-DC converter applicable to the display device shown in FIG. 1.

Referring to FIG. 2, the AC-DC converter 101a according to this embodiment includes a first filter 102a, a power rectification unit 102, a second filter 102b, an input capacitor Cin, and a power factor correction unit 104.

The first filter 102a may be an electromagnetic interference (EMI) filter provided to an input terminal of the power rectification unit 102. In this case, the EMI filter is operated to reduce noise in input alternating power during normal operation of the display device or the AC-DC converter 101a and to reduce surge pulses during abnormal operation thereof. Such an EMI filter may be realized by a common mode choke capable of reducing noise on both power lines of input alternating power, and two capacitors C1, C2 connected to both ends of the common mode choke.

The power rectification unit 102 serves to rectify the input alternating power and may be realized by a bridge diode which performs full-wave rectification of the input alternating power through four diodes thereof.

The second filter 102b may be an LC filter composed of a capacitor C and an inductor provided to the output terminal of the power rectification unit 102. With the second filter 102b, a resonance circuit is formed by combination of the capacitor C, which allows high frequency current to pass therethrough, and the inductor L, which does not allow high frequency current to pass therethrough, whereby high frequency noise can be selectively removed through the resonance circuit when generated at a power input terminal of the display device or the AC-DC converter 101a.

The input capacitor Cin is provided to an output terminal of the second filter 102b, that is, the output terminal of the power rectification unit 102, and is operated to stabilize the rectified power applied to the power factor correction unit 104.

In this embodiment, the high potential side output terminal of the power rectification unit 102, to which a first terminal of the input capacitor Cin and the inductor L of the second filter 102b are connected, corresponds to a first output terminal through which the rectified voltage V_{REC} is output from the AC-DC converter 101a of the display device.

The power factor correction unit 104 serves to correct a power factor of input alternating power based on the rectified power from the power rectification unit, and may be realized by an active power factor compensation circuit that includes an inductor L1, a switch S1, a diode D1 and an output capacitor Cout.

In the power factor correction unit 104, the inductor L1 includes a first terminal commonly connected to the first terminal of the input capacitor Cin and the high potentials side output terminal of the power rectification unit 102. The switch S1 is composed of a field effect transistor including a first terminal, a second terminal and a control terminal, in which the first terminal is connected to the second terminal of the inductor L1 and the second terminal is commonly connected to a second terminal of the input capacitor Cin and reference potential with a resistor R1 interposed therebetween. A control signal SC6 is applied from a given power factor correction (PFC) controller to the control terminal of the switch S1. The PFC controller may be realized by at least some functional sections of the backlight unit driver in the backlight module 140 (see FIG. 1) or at least some configuration of the backlight unit driver which can perform functions corresponding to the at least some functional sections.

Further, in the power factor correction unit 104, an anode of the diode D1 is commonly connected to the second terminal of the inductor L1 and the first terminal of the switch S1, and a cathode of the diode is connected to a first terminal of the output capacitor Cout. A second terminal of the output capacitor Cout is commonly connected to a low potential side output terminal of the power rectification unit 102, the second terminal of the input capacitor Cin and the second terminal of the switch S1.

In this embodiment, a node to which the cathode of the diode D1 of the power factor correction unit 104 and the first terminal of the output capacitor Cout are connected corresponds to a second terminal of the power factor correction unit 104 through which the power factor-corrected voltage V_{PFC} is output from the AC-DC converter 101a of the display device.

In operation of a discontinuous current mode (DCM), the switch S1 may be controlled to allow the power factor correction unit 104 to be turned on when electric current flowing through the inductor L1 is 0, and to be turned off when a voltage corresponding to a voltage between both ends of the resistor R1 and applied to a negative input terminal of the comparator is equal to the rectified voltage corresponding to voltage associated with current flowing through the inductor L1 and applied to a positive input terminal of the comparator. In this case, the power factor correction unit 104 allows an average waveform of the current (corresponding to rectified current) output from the power rectification unit 102 to follow the waveform of the rectified voltage, thereby making the power factor substantially approach 1.

In a conventional backlight module, a specific specification of an output capacitor (low ESR capacitor and the like) is generally considered in order to minimize ripples of output voltage in a power factor correction circuit. On the contrary, in the backlight module according to this embodiment, since the rectified voltage and the power factor-corrected voltage each having ripples of a certain magnitude are used, selection width of the power factor correction unit with respect to the output capacitor is widened as compared with the power factor correction circuit, thereby increasing the degree of freedom in terms of design.

In some embodiments, although not shown in the drawings, the AC-DC converter 101a may include a ripple removing part (not shown) provided to the input terminals of the backlight unit 120 to remove the ripples of driving power supplied to the backlight unit 120. Such a ripple removing part may be realized as a part of the backlight unit driver 130 or as a part of the backlight module 140, which is constituted by the backlight unit driver 130 and the backlight unit 120. The ripple removing part removes at least some of ripple components from the power factor-corrected voltage V_{PFC} provided from the power factor correction unit 104 to supply the power factor-corrected voltage V_{PFC}, from which at least some of ripple components are removed, to the backlight unit 120. When the magnitude of ripple components of the power factor-corrected voltage is too large, such a ripple removing part reduces power consumption caused by the ripple components by reducing the ripple components and can facilitate driving of the backlight unit 120.

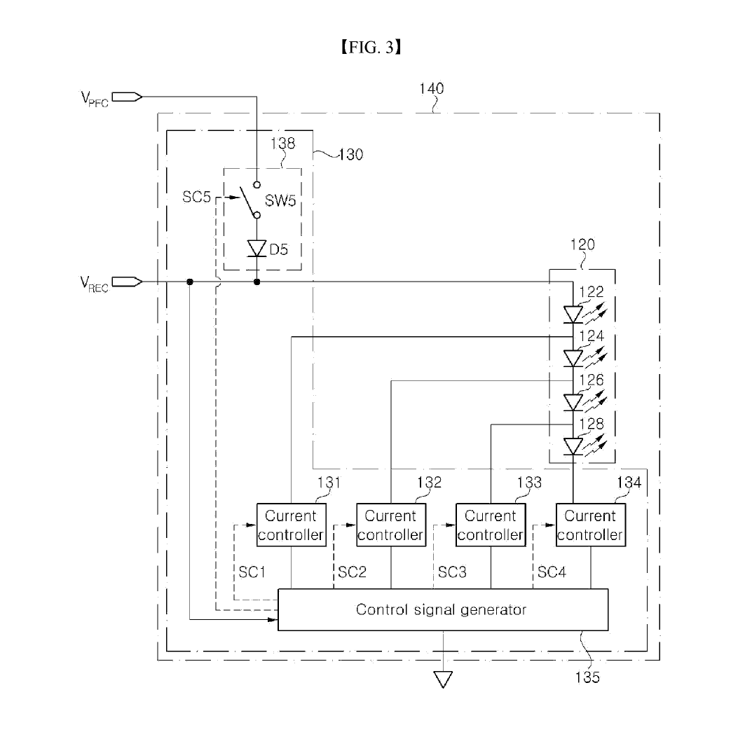

FIG. 3 is a block diagram of a backlight module applicable to the display device shown in FIG. 1.

Referring to FIG. 3, the backlight module 140 according to this embodiment includes the backlight unit 120 and the backlight unit driver 130.

The backlight unit driver 130 includes a plurality of current controllers 131 to 134, a control signal generator 135, and a voltage correction unit 138.

The plurality of current controllers 131 to 134 control paths and magnitudes of current flowing through first to fourth LED groups 122, 124, 126, and 128 in response to switching control signals SC1 to SC4. Here, each of the LED groups includes at least one light emitting diode. Each of the LED groups may include the plurality of light emitting diodes connected in series to each other.

More specifically, each of the current controllers 131 to 134 includes a switching device (not shown) and a feedback resistor (not shown). The switching device is connected between an output terminal of each of the LED groups (corresponding to a cathode of the light emitting diode) and one end of the feedback resistor, and is selectively turned on in response to the switching control signals SC1 to SC4. Here, the switching device may be a semiconductor switch such as a field effect transistor (FET) and controls the magnitude of current flowing through each of the LED groups in response to the switching control signals. The other end of the feedback resistor may be connected to reference potential or ground.

The control signal generator 135 generates switching control signals SC1 to SC4 and a correction switching control signal SC5 according to the rectified voltage V_{REC}, the magnitude of which periodically varies, and supplies the generated control signals to the current controllers 131 to 134 and the voltage correction unit 138.

For example, the control signal generator 135 detects current flowing through each of the light emitting diodes 122, 124, 126, and 128 via the current controllers 131 to 134, compares the detected current or voltage corresponding to the current with a preset reference value, and generates the switching control signals SC1 to SC4 according to a comparison result. In addition, the control signal generator 135 compares the rectified voltage V_{REC} with a preset reference value and generates the correction switching control signal SC5 according to a comparison result.

In this exemplary embodiment, the preset reference values may be determined based on any one of a voltage level corresponding to a minimum emissive reference of the backlight unit 120, and a forward voltage level Vf of one of the plurality of light emitting diodes 122, 124, 126, and 128.

The voltage correction unit 138 selectively supplies power factor-rectified power (V_{PFC} and the like) to the backlight unit 120 in response to the correction switching control signal SC5. The voltage correction unit 138 may be composed of a serial circuit of a switching device SW5 and a diode D5 connected between the output terminal of the power factor correction unit 104 and the input terminal of the backlight unit 120.

The switching device SW5 is realized by a field effect transistor including a first terminal, a second terminal and a control terminal, in which the first terminal is connected to the output terminal of the power factor correction unit and the second terminal is connected to an anode of the diode D5 such that the switching device SW5 is selectively turned on in response to the correction switching control signal SC5. A cathode of the diode D5 is commonly connected to the output terminal of the power rectification unit and the input terminal of the backlight unit 120. The diode D5 prevents reverse flow of the rectified power V_{REC} to the power factor correction unit 104 when the switching device SW5 is turned off.

The backlight unit 120 includes at least one LED array in which the plural LED groups 122 to 128, each including at least one LED, are connected in series to each other. The backlight unit 120 performs multi-stage driving such that a lighting state of the light emitting diodes is controlled according to an increasing or decreasing extent of the voltage of the alternating power or the rectified power by current control of the backlight unit driver 130.

The backlight unit 120 may perform multi-stage driving such that the number of LED groups emitting light in the LED array gradually increases as the rectified voltage increases, and gradually decreases as the rectified voltage decreases. Particularly, the backlight unit 120 is operated to prevent formation of a non-light emitting section during multi-stage driving by receiving the power factor-corrected voltage from the power factor correction unit to drive at least one LED group. Herein, the non-light emitting section refers to a section in which the rectified voltage is less than a forward voltage of one LED group, and in the non-light emitting section, all of the LED groups of the backlight unit 120, that is, all of the light emitting diodes, are in a turn-off state. In such a turn-off state, the backlight module resolves the problem of high efficiency multi-stage driving by removing the non-light emitting section, which causes flickering, using the power factor-corrected voltage, whereas the existing backlight unit can cause flickering in the course of multi-stage driving.

In FIG. 3, the backlight unit 120 is illustrated as including four LED groups 122, 124, 126, and 128 each represented by a single light emitting diode for convenience of description. However, it should be understood that this structure is provided for illustration only, and the number of light emitting diodes in each of the LED groups, the number of LED groups, the number of current controllers, and detailed features thereof may be selected in various ways. For example, the backlight unit 120 may include two or more LED groups connected in series to each other, or may include a plurality of LED groups connected in series or parallel to each other.

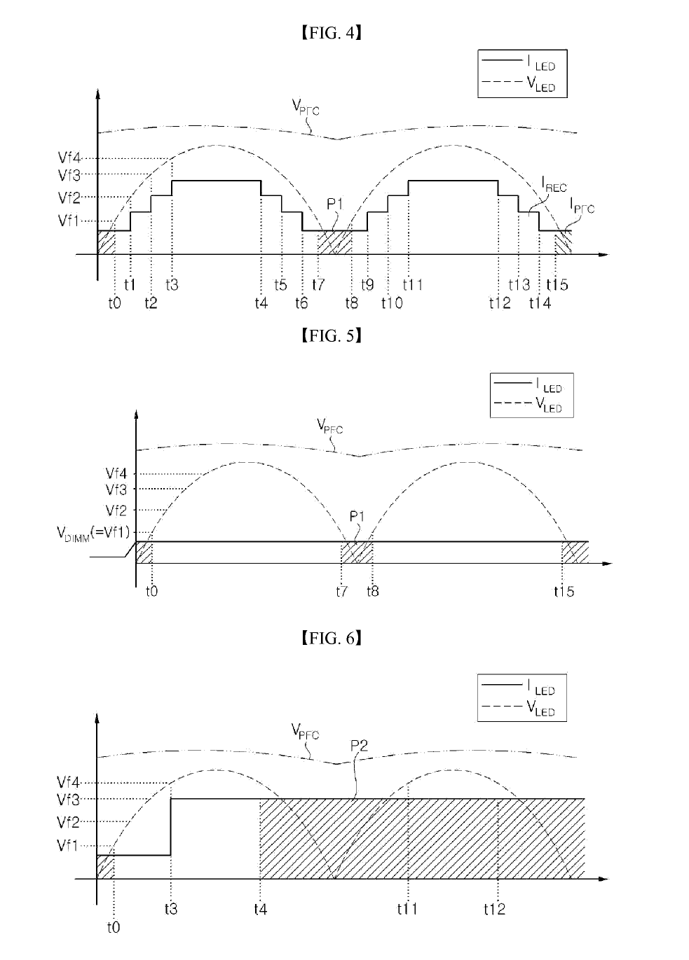

FIG. 4 shows a waveform graph depicting an operating principle of the backlight module in the display device shown in FIG. 1.

By way of example, as shown in FIG. 3, the backlight module of the display device according to this embodiment includes the backlight unit 120, which includes the plurality of LED groups 122, 124, 126, and 128, the current controllers 131 to 134, the control signal generator 135 and the voltage correction unit 138, in which all of the LED groups 122, 124, 126, and 128 have a predetermined forward voltage Vf. In addition, the LED groups will be sequentially referred to as a first LED group 122, a second LED group 124, a third LED group 126 and a fourth LED group 128, respectively, and the current controllers connected to output terminals of the LED groups will be referred to as a first current controller 131, a second current controller 132, a third current controller 133 and a fourth current controller 134, respectively.

Referring to FIG. 4, first, the switching device of each of the current controllers 131 to 134 is maintained in a turn-on state, and the switching device SW5 of the voltage correction unit 138 is maintained in a turn-off state. In this state, when a rectified voltage V_{REC} applied to the backlight module reaches a first voltage Vf1 or more at a given time point t0, a current path is formed to pass through the first LED group 122 and the first current controller 131 such that the first LED group 122 emits light. At this time, the first current controller 131 controls the magnitude of current flowing through the first LED group 122 depending upon a preset current level based on the first voltage Vf1.

The backlight module may be set to supply the power factor-corrected voltage V_{PFC} to the backlight unit 120 when the rectified voltage V_{REC} is less than the first voltage Vf1. In this case, the backlight module 140 according to this embodiment supplies a certain level of power factor-corrected current I_{PFC} set by the first current controller 131 to the backlight unit 120 in a slash line section from a certain time point before the given time point t0 to the given time point t0.

When the rectified voltage increases to a second voltage Vf2 at a first time point t1, the control signal generator 135 turns off the switching device of the first current controller 131. Then, a current path is formed to pass through two LED groups 122 and 124 and the second current controller 132, whereby two LED groups 122 and 124 emit light. At this time, the second current controller 132 controls the magnitude of current I_{REC} flowing through the two LED groups 122 and 124 corresponding to the magnitude of the rectified voltage.

When the rectified voltage increases to a second voltage Vf3 at a second time point t2, the control signal generator 135 turns off the switching device of the first current controller 131 and the switching device of the second current controller 132. Then, a current path is formed to pass through three LED groups 122, 124, and 126 and the third current controller 133, whereby three LED groups 122, 124, and 126 emit light. At this time, the third current controller 133 controls the magnitude of current I_{REC} flowing through the three LED groups 122, 124, and 126 corresponding to the magnitude of the rectified voltage.

When the rectified voltage increases to a third voltage Vf4 at a third time point t3, the control signal generator 135 turns off the switching devices of the first to third current controllers 131, 132, and 134. Then, a current path is formed to pass through four LED groups 122, 124, 126, and 128 and the fourth current controller 134, whereby four LED groups 122, 124, 126, and 128 emit light. At this time, the fourth current controller 134 controls the magnitude of current I_{REC} flowing through the four LED groups 122, 124, 126, and 128 corresponding to the magnitude of the rectified voltage.

As described above, the control signal generator 135 allows multi-stage driving of the plurality of LED groups 122, 124, 126, and 128 such that the number of LED groups emitting light in the backlight unit 120 increases with increasing magnitude of the rectified voltage.

When the magnitude of the rectified voltage decreases, the control signal generator 135 sequentially turns off the LED groups in reverse order of increasing the rectified voltage. That is, when the rectified voltage decreases below the fourth voltage Vf4 at a fourth time point t4, the control signal generator 135 drives the third current controller 133 to form a current path passing through the three LED groups 122, 124, and 126 and the third current controller 133, whereby the three LED groups 122, 124, and 126 emit light. When the rectified voltage decreases below the third voltage Vf3 at a fifth time point t5, the control signal generator 135 drives the second current controller 132 to form a current path passing through the two LED groups 122 and 124 and the second current controller 132, whereby the two LED groups 122 and 124 emit light. In addition, when the rectified voltage decreases below the second voltage Vf2 at a sixth time point t6, the control signal generator 135 drives the first current controller 131 to form a current path passing through the first LED group 122 and the first current controller 131, whereby the first LED group 122 emits light

When the rectified voltage decreases below a preset reference value, for example, the first voltage Vf1, at a seventh time point t7, the control signal generator 135 turns on the switching device SW5 of the voltage correction unit 138 at the seventh time point t7.

Since the power factor-corrected voltage V_{PFC} has a higher voltage level than the forward voltage Vf4 of the plurality of LED groups 122, 124, 126, and 128, the control signal generator 135 can supply a power factor-corrected current I_{PFC} to the first LED groups 122 through a current path passing through the first LED group 122 and the second current controller 131 in a section from the seventh time point t7 to an eighth time point t8. Here, the section from the seventh time point t7 to the eighth time point t8 corresponds to a non-light emitting section in the case where the power factor-corrected voltage V_{PFC} is not supplied to the backlight unit 120.

Further, when the rectified voltage V_{REC} reaches a preset reference value, for example, the first voltage Vf1, at the eighth time point t8, the control signal generator 135 turns off the switching device SW5 of the voltage correction unit 138 at the eighth time point t8.

As described above, the backlight module 140 according to this embodiment supplies the power factor-corrected voltage V_{PFC} to the backlight unit 120 when the rectified voltage V_{REC} is less than the first voltage Vf1, whereby the backlight module 140 can supply a certain level of power factor-corrected current I_{PFC} set by the first current controller 131 to the backlight unit 120 in a slash line section t7-t8, thereby removing the non-light emitting section.

In this embodiment, the rectified voltage V_{REC} corresponds to a drive voltage V_{LED} of the backlight unit 120, and combination of the rectified current I_{REC} based on the rectified voltage V_{REC} and the power factor-corrected current I_{PFC} based on the power factor-corrected voltage V_{PFC} corresponds to a drive current I_{LED} of the backlight unit 120.

The backlight module according to this embodiment may receive a predetermined voltage Va or a predetermined signal from the display module 101 (see FIG. 1) in order to control brightness and the like of the backlight unit 120. The predetermined voltage Va may be a reference voltage and the predetermined signal may be a dimming signal.

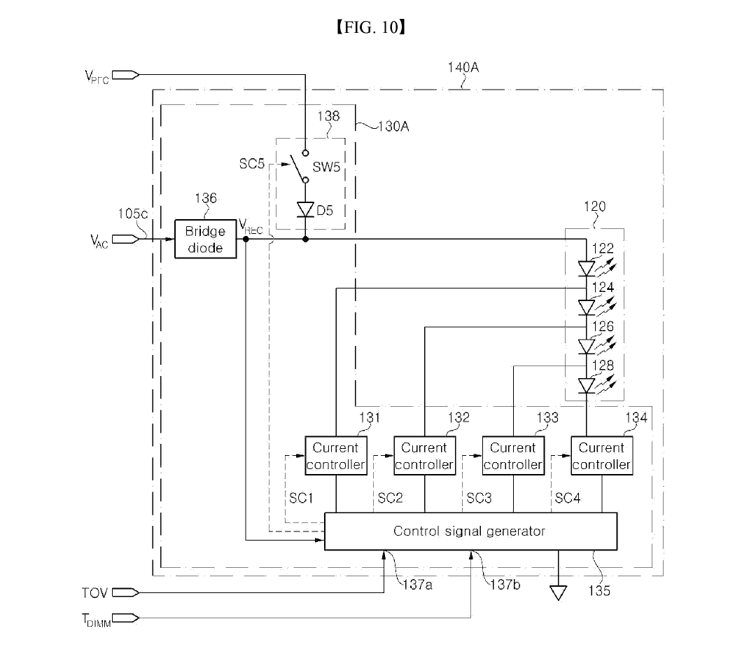

Next, an operating principle of the backlight module receiving a dimming signal V_{DIMM} (see FIG. 10) from a signal processing unit of the display module will be described. For convenience of description, assume that the dimming signal is received in the course of multi-stage driving of the backlight module described above with reference to FIG. 4.

FIG. 5 and FIG. 6 are waveform graphs depicting an illumination principle applicable to the display device shown in FIG. 1.

By way of example, assume that a dimming signal is set to maintain a brightness level corresponding to a voltage level, for example, the first voltage Vf1, which corresponds to the minimum emissive reference of the backlight unit 120, irrespective of brightness variation of image signals.

Referring to FIG. 5, in response to the dimming signal from the signal process of the display module during multi-stage driving of the backlight unit 120, the backlight unit driver is operated to allow a drive current I_{LED} corresponding to a voltage level (for example, the first voltage) set by the dimming signal to be supplied to the backlight unit 120.

A conventional multi-stage driving type backlight unit generates non-light emitting sections corresponding to slash line sections in the graph during dimming operation, whereas the backlight module according to this embodiment can prevent generation of such non-light emitting sections in the backlight unit during the dimming operation by supplying the power factor-corrected voltage V_{PFC} and a power factor-corrected current, the magnitude of which is preset by the first current controller 131, to the backlight unit in the slash line sections (P1 and the like) corresponding to the non-light emitting sections.

Next, assume that the dimming signal is set to maintain a brightness level corresponding to the fourth voltage Vf4 at a time point t3.

Referring to FIG. 6, when the backlight unit 120 receives a novel dimming signal from the signal processing unit of the display module at the time point t3 during operation at a voltage level as shown in FIG. 5, the backlight unit driver is operated to allow a drive current I_{LED} corresponding to a voltage level (for example, the fourth voltage Vf4) set by the novel dimming signal to be supplied to the backlight unit 120.

Due to lack of energy resulting from multi-stage driving, the conventional multi-stage driving type backlight unit generates the non-light emitting sections corresponding to the slash line sections during dimming operation, whereas the backlight module according to this embodiment can prevent generation of such non-light emitting sections in the backlight unit during the dimming operation by supplying the power factor-corrected current corresponding to the level of the dimming signal to the backlight unit in response to operation of the fourth current controller 134 in the slash line sections (P2 and the like).

As described above, when the level of the dimming signal increases from a low level to a high level, the present invention can prevent generation of the non-light emitting sections in the backlight unit 120 using the power factor-corrected voltage V_{PFC}. In other words, the backlight module according to the present invention allows the backlight unit 120 to be normally operated at a high level of the dimming signal by supplementing energy to the backlight unit using the power factor-corrected voltage output from the power factor correction unit 104 during sections corresponding to the non-light emitting sections.

Although the backlight module according to this embodiment has been described as being capable of removing the non-light emitting sections generated in the conventional multi-stage driving type backlight module in response to the dimming signal for convenience of description, it should be understood that the present invention is not limited thereto. Rather, when there is a non-light emitting section in which all of the light emitting diodes of the backlight unit are not substantially operated in the backlight module operated by ripple voltage instead of multi-stage driving, the present invention may also include all features using the power factor-corrected voltage to remove such a non-light emitting section.

In addition, reference brightness in operation of the backlight unit 120, the number of light emitting diodes to be lit according to the reference brightness, or a voltage level to be corrected may be changed by a user, as needed. In addition, it should be understood that the waveform graphs shown in FIG. 5 and FIG. 6 are provided for illustration only and the number of LED groups to be turned on, a time point of turning on the LED groups, and the like may be changed in various ways according to the configuration of the current controllers. Further, typical display devices such as liquid crystal displays and the like require a separate converter for generating DC power for driving the backlight module, whereas the backlight module according to the present invention and a display device using the same can omit a DC-DC converter for the backlight unit and can directly drive the backlight unit via alternating power, thereby enabling reduction in size and manufacturing costs of devices.

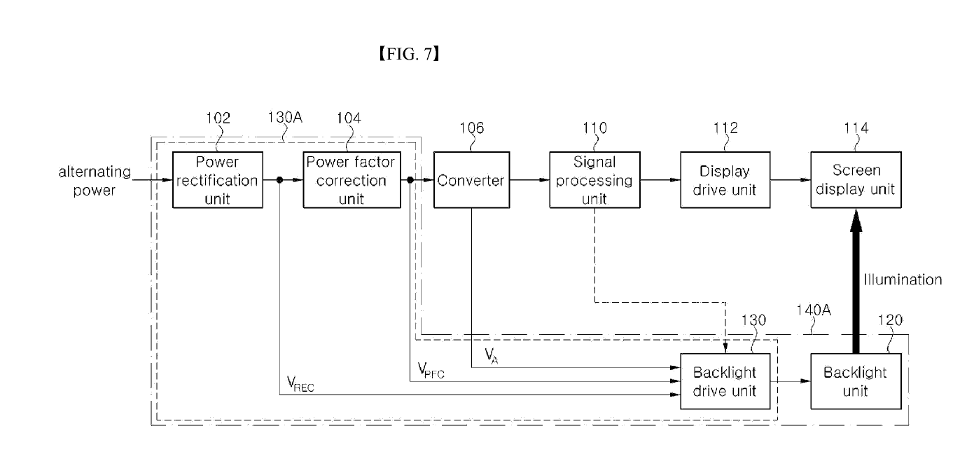

FIG. 7 is a schematic block diagram of a display device according to one embodiment of the present invention.

Referring to FIG. 7, the display device according to this embodiment includes a power rectification unit 102, a power factor correction unit 104, a converter 106, a signal processing unit 110, a display drive unit 112, a screen display unit 114, and a backlight module 140A. The converter 106, the signal processing unit 110, the display drive unit 112 and the screen display unit 114 correspond to the display module 101 of FIG. 1. The display device according to this embodiment may further include a filter disposed at an input terminal or an output terminal of the power rectification unit 102.

The power rectification unit 102 rectifies alternating power to supply rectified alternating power to the power factor correction unit 104. For example, the power rectification unit 102 may be realized by a bridge diode which performs full-wave rectification of alternating power in a sine wave form.

The power factor correction unit 104 outputs power factor-rectified power by correcting a power factor in an alternating power source 10 based on the rectified power output from the power rectification unit 102. The power factor-rectified power has a certain level of DC voltage. For example, when the alternating power source 10 supplies an AC voltage of 220 V, the power factor-rectified power has a voltage of about 380 V to about 420 V. The power factor correction unit 104 may be realized by a plurality of passive elements or active elements. For example, the power factor correction unit may include an active power factor correction circuit in the form of a boost converter.

The converter 106 generates DC power having a level for driving the signal processing unit 110 and the display drive unit 112 by receiving the power factor-rectified power. Specifically, the DC power output from the converter 106 may be used to drive various processors included in the signal processing unit 110. In addition, the DC power is supplied to a gate line or a data line of the screen display unit 114 through the display drive unit 112, such that an image is displayed on the screen display unit.

The signal processing unit 110 processes various image signals input from outside to generate various control signals and supplies the generated control signals to the display drive unit 112. For example, the signal processing unit 110 processes an image signal to generate a control signal for controlling voltage to be applied to a data line or a gate line of the screen display unit 114.

In addition, the signal processing unit 110 generates a control signal (hereinafter, dimming signal) for controlling brightness and an on/off time point of the backlight unit 120, and supplies the generated control signals to the backlight unit driver 130. Here, the dimming signal may include a signal for local dimming when the backlight unit 120 includes a local dimming structure, brightness of which is controlled depending upon regions.

The display drive unit 112 drives the screen display unit 114 in response to output from the signal processing unit 110. The display drive unit 112 may include a gate driver connected to pixels of the screen display unit 114 via a gate line, a data driver connected to the pixels of the screen display unit via a data line, and a timing controller controlling operation timing of the gate driver and the data driver.

The screen display unit 114 is provided with a plurality of pixels arranged in a matrix to allow a certain image to be output in response to an image signal. The plurality of pixels may include liquid crystals capable of regulating transmission of light by illumination of the backlight unit 120, electrodes for controlling the liquid crystals, and color filters for expressing colors.

The backlight module 140 includes the backlight unit 120 providing illumination for the screen display unit 114 and the backlight unit driver 130 driving the backlight unit 120. The backlight unit driver 130 receives rectified power and power factor-rectified power, and controls operation of the backlight unit 120 in response to a dimming signal from the signal processing unit 110.

Since a method for using the power factor-rectified power to prevent generation of the non-light emitting section during driving of the backlight unit in the backlight module 140 according to this embodiment is described with reference to FIG. 1 to FIG. 6, a repetitive detailed description thereof will be omitted.

In the display device according to this embodiment, the power rectification unit 102 and the power factor correction unit 104 may be realized by a single AC-DC converter which outputs the power factor-rectified power through correction of the power factor of alternating power. In addition, the power rectification unit 102, the power factor correction unit 104 and the backlight unit driver 130 may be realized by a single integrated circuit 130A for backlight driving, which has a power factor correcting function. In this case, the backlight module 140A corresponds to a component including a backlight unit driver having the power factor correcting function. Of course, the backlight unit driver having the power factor correcting function may be realized by a single integrated circuit which includes the power factor correction unit 104 without the power rectification unit 102, or by a single integrated circuit which includes the power rectification unit 102 without the power factor correction unit 104.

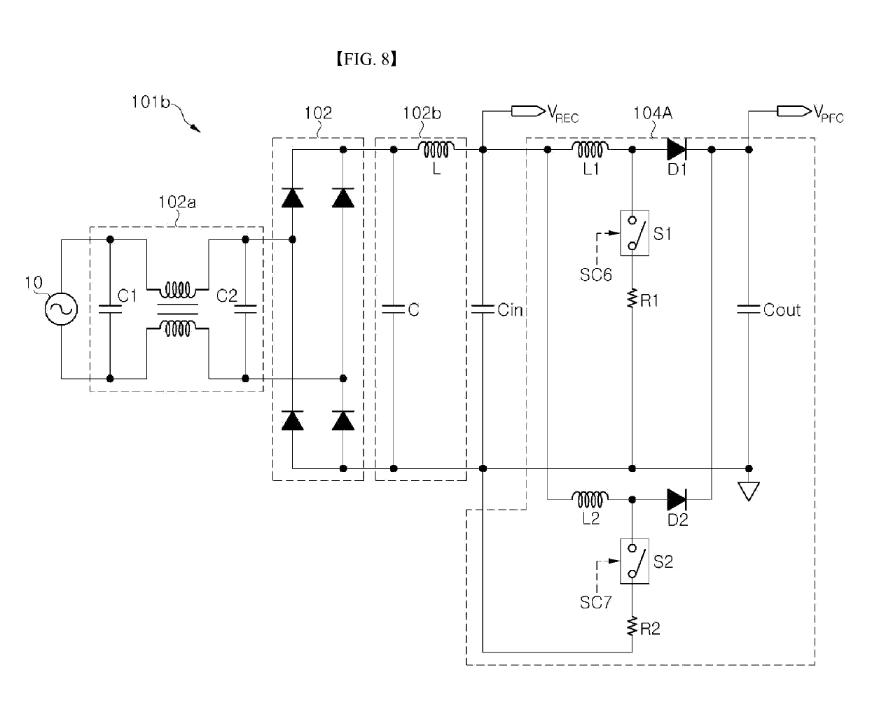

FIG. 8 is a circuit diagram of an AC-DC converter applicable to the display device shown in FIG. 7

Referring to FIG. 8, an AC-DC converter 101b of the display device according to this embodiment is an interleaved boost converter in which two boost converters are connected in parallel.

The AC-DC converter 101b according to this embodiment is realized by parallel connection of two AC-DC converters 101a described above in FIG. 3a. An inductor L2, a switch S2, a resistor R2 and a diode D2 of the added boost converter and a connection relationship therebetween are substantially the same as the elements of the AC-DC converter 101a and the connection relationship therebetween, and thus a repetitive detailed description thereof will be omitted.

With such a multi-phase boost converter type AC-DC converter 101b, an input voltage corresponding to a voltage between both ends of the input capacitor Cin and an output voltage corresponding to a voltage between both ends of the output capacitor Cout can be divided into half, whereby the volume or capacitance of each of the capacitors C1, C2 or the inductor L1, L2 can be reduced, as compared with the single boost converter type AC-DC converter 101a, thereby enabling thickness reduction of flat panel displays while improving operation efficiency through reduction in power consumption by reducing current flowing through the AC-DC converter 101b.

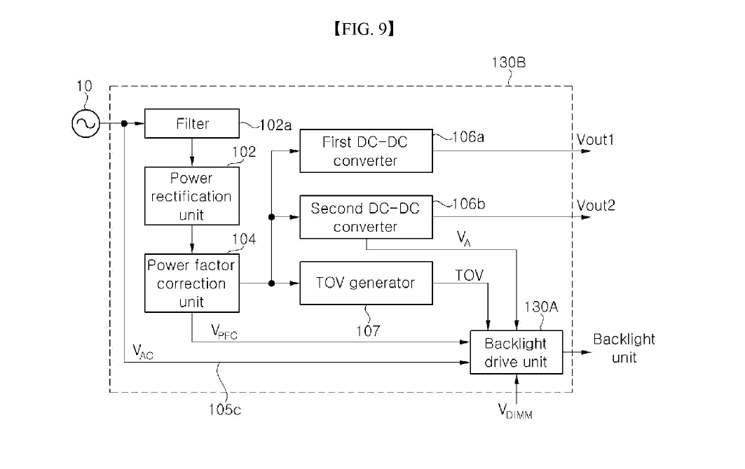

FIG. 9 is a block diagram of a power supply for a display device according to a further embodiment of the present invention.

Referring to FIG. 9, a power supply 130B of the display device according to this embodiment includes a filter 102a, a power rectification unit 102, a power factor correction unit 104, a first DC-DC converter 106a, a second DC-DC converter 106b, a temporary over voltage (TOV) generator 107, and a backlight unit driver 130A. The power supply 130B may be a switch mode power supply which has both a power factor correction function and a backlight unit driving function.

The first DC-DC converter 106a corresponds to a DC-DC converter for standby power and the second DC-DC converter 106b corresponds to a DC-DC converter for power of the display module. In this case, the second DC-DC converter 106b may correspond to a converter that supplies module driving power Vout2 to a power management integrated circuit (PMIC) of the display module, and the first DC-DC converter 106a may corresponds to a converter that supplies standby power Vout 1 separated from the second DC-DC converter 106b in order to operate the display device with minimum standby power when the display device is first turned on. In some embodiments, the first and second DC-DC converters 106a, 106b may be integrated into a single DC-DC converter.

In the power supply 130B according to this embodiment, the backlight unit driver 130A included in the backlight module may include a separate power rectification unit, which rectifies alternating power input through an interconnection line 105c connected to an input terminal of the power rectification unit 102 and supplies the rectified power to the backlight unit.

In addition, not only does the backlight unit driver 130A of the power supply 130B according to this embodiment prevent generation of a non-light emitting section in the backlight unit using the power factor-corrected voltage V_{PFC}, but also allows the plurality of LED groups in the backlight unit to be driven by high voltage by increasing the drive voltage of the backlight unit by a predetermined reference voltage (TOV), thereby improving operation efficiency through high voltage low current driving. Here, the high voltage means a voltage which is higher than a maximum value of alternating voltage V_{AC} or rectified voltage V_{REC} of the input alternating power source 10.

FIG. 10 is a block diagram of a backlight module applicable to the display device shown in FIG. 9.

Referring to FIG. 10, a backlight module 140A according to this embodiment includes a backlight unit 120 and a backlight unit driver 130A, which is disposed in an SMPS type power supply (see 130B).

In this embodiment, since the backlight unit 120 is the same as the backlight unit of the other embodiment described above, a detailed description thereof is omitted to avoid repetition. In addition, since the backlight unit driver 130A has substantially the same configuration as that of the backlight unit driver 130 described with reference to FIG. 3 except for a bridge diode 136, a first input terminal 137a and a second input terminal 137b, detailed descriptions of other components of the backlight unit driver 130A (a plurality of current controllers, a control signal generator and a voltage correction unit, and a connection relationship therebetween) and the operating principle thereof are omitted to avoid repetition.

In the backlight unit driver 130A, the bridge diode 136 rectifies alternating power input through an interconnection line 105c connected to the input terminal of the power rectification unit 102 (see FIG. 9) in the display device and supplies the rectified power to the backlight unit 120. The bridge diode 136 corresponds to a separate power rectification unit independent of the power rectification unit 102 in the display device. With such a bridge diode 136, the backlight module 140A may be driven using directly input alternating power separate from the power supply of the display device.

The first input terminal 137a corresponds to an input terminal of a reference voltage (temporary overvoltage, TOV) and the second input terminal 137b corresponds to an input terminal of a dimming signal V_{DIMM}. Here, the reference voltage (TOV) is set to allow the plurality of LED groups of the backlight unit to be driven by high voltage by increasing the drive voltage of the backlight unit by a predetermined reference voltage (TOV). In addition, the dimming signal V_{DIMM} is provided to regulate brightness of the backlight unit corresponding to brightness of images displayed on the screen display unit.

The backlight unit driver 130A is operated such that overall brightness of the backlight unit follows the level of the dimming signal (average level or the like) for a predetermined duration. In order to allow the overall brightness of the backlight unit to follow the level of the dimming signal, in multi-stage driving, the backlight unit driver 130A may set an average level of the dimming signal in each multi-stage driving section as a target level to follow.

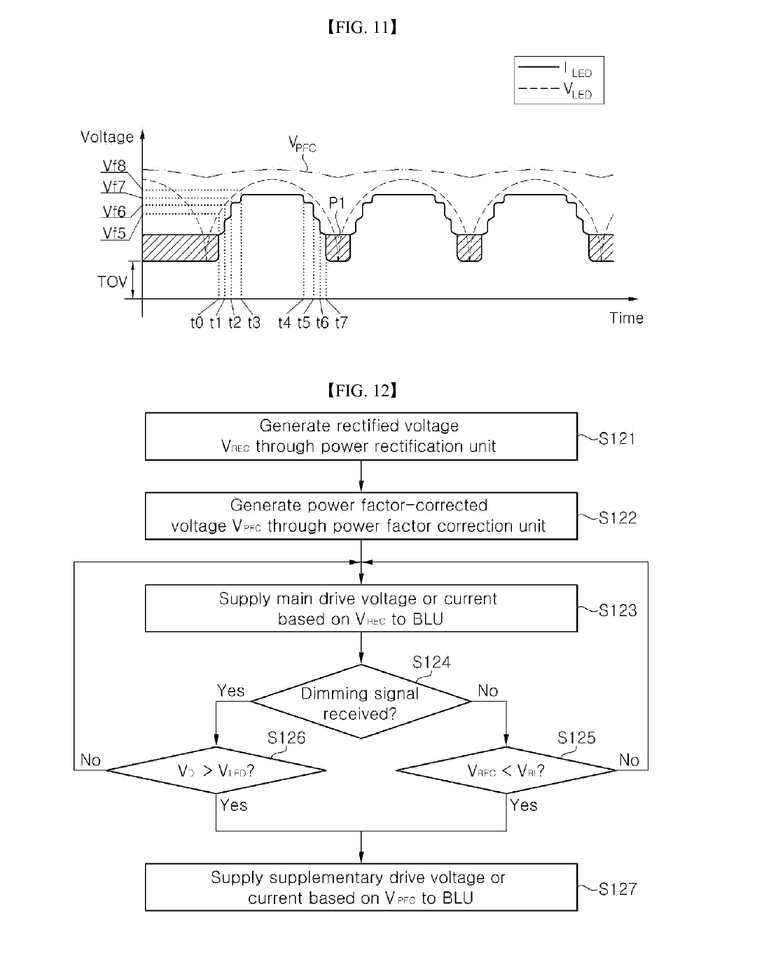

FIG. 11 is a waveform graph depicting an operating principle of the display device shown in FIG. 9.

Referring to FIG. 11, the display device according to this embodiment allows multi-stage driving of the plurality of LED groups in the backlight unit using a drive voltage V_{LED}, the magnitude of which is increased to a predetermined value by the reference voltage (TOV), and a drive current I_{LED}.

With the exception that the first to fourth voltages Vf5, Vf6, Vf7, and Vf8 used as reference values for multi-stage driving of the plurality of LED groups are increased by the reference voltage (TOV) above the first to fourth voltages Vf1, Vf2, Vf3, and Vf4 described above with reference to FIG. 4, the display device according to this embodiment is operated by substantially the same principle as that of the display device shown in FIG. 4, and thus a detailed description thereof is omitted to avoid repetition.

In this exemplary embodiment, depending upon the first to fourth voltages Vf5, Vf6, Vf7, Vf8, the forward voltages of the first to fourth LED groups 122, 124, 126, and 128 are higher than the input alternating voltage or the rectified voltage. To this end, each LED group may employ LEDs having a higher forward voltage than each of the LED groups of FIG. 4, or a greater number of LEDs than the LED groups of FIG. 4.

FIG. 12 is a flowchart of a method of driving a backlight module according to the present invention.

In this embodiment, the method of driving a backlight module will be described mainly with reference to a process of driving the backlight module by a backlight unit driver that drives a backlight unit to provide illumination to the display device. Herein, the backlight unit includes a plurality of LED groups each including at least one light emitting diode.

Referring to FIG. 12, in the backlight module driving method according to this embodiment, first, alternating power input through a power rectification unit is rectified to generate a rectified voltage (S121). The rectified voltage includes a ripple component voltage, the magnitude of which periodically varies over time.

Then, a power factor of the alternating power is corrected through a power factor correction unit disposed at an output terminal of the power rectification unit to generate a power factor-corrected voltage (S122). The power factor-corrected voltage includes a DC component having a predetermined magnitude or more. Here, the predetermined magnitude corresponds to direct voltage capable of driving all of the light emitting diodes in the backlight unit.

The rectified voltage is received to generate a main drive voltage or a main drive current, and the generated main drive voltage or main drive current is supplied to the backlight unit (S123).

In S123, the backlight unit driver may control the backlight unit based on the rectified voltage, the magnitude of which periodically varies over time, such that the number of LED groups emitting light among the plurality of LED groups increases as the rectified voltage increases, and such that the number of LED groups emitting light among the plurality of LED groups decreases as the rectified voltage decreases.

When a dimming signal is not received or the rectified voltage is less than a preset critical value, the backlight unit driver supplies a supplementary drive voltage or a supplementary drive current based on the power factor-corrected voltage to the backlight unit (S124, S125 and S127).

In these series of operations S124, S125 and S127, the backlight unit driver may supply the supplementary drive voltage or the supplementary drive current based on the power factor-corrected voltage V_{PFC} to the backlight unit (BLU), when the rectified voltage V_{REC} is less than a minimum voltage V_{R1} for driving at least one LED group among the plurality of LED groups.

The backlight module driving method according to this embodiment may further include receiving a dimming signal from the display module to control the backlight unit driver to generate a preset dimming voltage or a preset dimming current. In this case, when the dimming signal is received and the preset dimming voltage V_{DI} is higher than an LED drive voltage V_{LED} or the preset dimming current is higher than an LED drive current, the supplementary drive voltage or supplementary drive current based on the power factor-corrected voltage V_{PFC} is supplied to the backlight unit (S124, S126 and S127).

In this exemplary embodiment, the dimming signal may correspond to a control signal for maintaining brightness of the backlight unit at a preset level. The backlight unit driver may generate a preset dimming voltage or a preset dimming current corresponding to brightness of the backlight unit preset according to the level of the dimming signal. In addition, the preset dimming voltage or the preset dimming current corresponds to the LED drive voltage or the LED drive current corresponding to the level of the dimming signal. The LED drive voltage corresponds to the sum of the main drive voltage and the supplementary drive voltage, and the LED drive current corresponds to the sum of the main drive current and the supplementary drive current.

In this embodiment, the backlight unit driver may control the backlight unit such that the overall brightness of the backlight unit follows the level of the dimming signal (average level in a predetermined section) depending upon the level of the dimming signal.

Although some embodiments have been described above, it should be understood that the present invention is not limited to these embodiments, and various modifications, changes, and alterations can be made by those skilled in the art without departing from the spirit and scope of the present invention defined by the attached claims and equivalents thereof.

1. A display device comprising:
a power rectification unit configured to rectify alternating power to output a rectified voltage;
a power factor correction unit configured to receive the rectified voltage from the power rectification unit and correct a power factor of the alternating power to output a power factor-corrected voltage comprising a direct voltage component having at least a predetermined magnitude;
a display module configured to be driven by the power factor-corrected voltage;
a backlight unit comprising light emitting diodes (LEDs) configured to provide backlight illumination to the display module; and
a backlight unit driver configured to generate a main drive voltage or a main drive current and supply the main drive voltage or the main drive current to the backlight unit by receiving the rectified voltage, generate a supplementary drive voltage or a supplementary drive current, and supply the supplementary drive voltage or the supplementary drive current to the backlight unit by receiving the power factor-corrected voltage when the rectified voltage is less than a preset critical value.

2. The display device according to claim 1, wherein the backlight unit driver is configured to supply the supplementary drive voltage or the supplementary drive current to the backlight unit when the main drive voltage is less than a minimum voltage for driving at least one light emitting diode.

3. The display device according to claim 1, wherein the display module is configured to generate a dimming signal to control the backlight unit driver to generate a preset dimming voltage or a preset dimming current, and, in response to the dimming signal, the backlight unit driver is configured to supply the supplementary drive voltage to the backlight unit when the main drive voltage is less than the preset dimming voltage, or supply the supplementary drive current to the backlight unit when the main drive current is less than the preset dimming current.

4. The display device according to claim 1, further comprising:
a first interconnection line connecting an output terminal of the power rectification unit to a first input terminal of the backlight unit driver and configured to transfer the rectified voltage from the power rectification unit to the backlight unit driver; and
a second interconnection line connecting an output terminal of the power factor correction unit to a second input terminal of the backlight unit driver and configured to transfer the power factor-corrected voltage from the power factor correction unit to the backlight unit driver.

5. The display device according to claim 1, wherein the backlight unit driver is configured to control the backlight unit based on the rectified voltage, the magnitude of which periodically varies over time, such that the number of light emitting diodes emitting light among the light emitting diodes increases as the rectified voltage increases, and such that the number of light emitting diodes emitting light among the light emitting diodes decreases as the rectified voltage decreases.

6. The display device according to claim 5, wherein the backlight unit driver comprises;
current controllers each connected between a reference potential and an output terminal of each LED group of a plurality of LED groups, each LED group comprising at least one light emitting diode, and forming a current path between the reference potential and the output terminal of each of the LED groups; and
a control signal generator configured to apply a control signal to the plurality of current controllers to control operation of the plurality of current controllers depending upon the magnitude of the main drive voltage.

7. The display device according to claim 6, wherein the backlight unit driver further comprises a voltage correction unit disposed between an output terminal of the power factor correction unit and an input terminal of the backlight unit, the voltage correction unit configured to regulate supply of the power factor-corrected voltage to the backlight unit.

8. The display device according to claim 7, wherein the voltage correction unit comprises;
a switching device comprising a first terminal connected to the output terminal of the power factor correction unit; and
a diode comprising an anode connected to a second terminal of the switching device and a cathode connected to the input terminal of the backlight unit,
wherein the switching device is configured to be turned on or off in response to the control signal from the control signal generator.

9. The display device according to claim 8, wherein the backlight unit driver is configured to apply the control signal to the voltage correction unit to supply the supplementary drive voltage or the supplementary drive current based on the power factor-corrected voltage to the plurality of LED groups when the rectified voltage is less than a minimum voltage for driving at least one LED group among the plurality of LED groups.

10. The display device according to claim 6, wherein, in response to a dimming signal from the display module to control the backlight unit driver to generate a preset dimming voltage or a preset dimming current, the backlight unit driver is configured to supply the supplementary drive voltage to the backlight unit when the main drive voltage is less than the preset dimming voltage, or supply the supplementary drive current to the backlight unit when the main drive current is less than the preset dimming current.

11. The display device according to claim 1, wherein the power rectification unit comprises a first power rectifier provided to an input terminal of the power factor correction unit and configured to supply the rectified voltage obtained by rectifying the alternating power to the power factor correction unit; and a second power rectifier provided to the backlight unit driver and configured to supply the rectified voltage obtained by rectifying the alternating power to the backlight unit.

12. The display device according to claim 1, wherein the power factor correction unit comprises:
an inductor comprising a first terminal connected to a high potential side first terminal of an input capacitor connected in series to an output terminal of the power rectification unit;
a switch comprising a first terminal connected to a second terminal of the inductor and a second terminal connected to a low potential side second terminal of the input capacitor; and
a diode comprising an anode commonly connected to the second terminal of the inductor and the first terminal of the switch and a cathode connected to a high potential side first terminal of an output capacitor,
wherein the output capacitor comprises the first terminal connected to the cathode of the diode and a second terminal commonly connected to the low potential side second terminal of the input capacitor and the second terminal of the switch.

13. The display device according to claim 12, wherein the power factor correction unit comprising an interleaved boost converter structure in which two power factor correction units, each comprising the inductor, the switch, the diode and the output capacitor, are connected in parallel to each other.

14. The display device according to claim 12, wherein at least one of the power rectification unit and the power factor correction unit is arranged in the form of a single integrated circuit with the backlight unit driver.

15. A backlight module, comprising:
a power factor correction unit configured to correct a power factor of alternating power to output power factor-rectified power;
a backlight unit comprising light emitting diodes; and
a backlight unit driver configured to drive the light emitting diodes in response to a dimming signal, the backlight unit driver configured to selectively supply the alternating power and the power factor-rectified power to the light emitting diodes according to the dimming signal and a magnitude of the alternating power.

16. The backlight module according to claim 15, wherein the backlight unit comprises the light emitting diodes connected in series to each other, and the backlight unit driver comprises:
a power rectification unit configured to rectify alternating power to supply a rectified voltage to the backlight unit;
current controllers each connected between a reference potential and one side terminal of each of the light emitting diodes and forming a current path between the reference potential and the light emitting diode; and
a control signal generator configured to generate a control signal to control operation of the current controllers according to the dimming signal and a magnitude of the rectified voltage.

17. The backlight module according to claim 16, wherein the control signal generator is configured to regulate electric current flowing through the backlight unit by controlling operation of the current controllers depending upon a level of the dimming signal.

18. The backlight module according to claim 15, further comprising:
a voltage correction unit configured to supply a voltage output from the power factor correction unit to the backlight unit depending upon a magnitude of the rectified voltage and a level of the dimming signal.

19. The backlight module according to claim 18, wherein the voltage correction unit is configured to supply the voltage output from the power factor correction unit to the backlight unit during a section in which the rectified voltage is less than or equal to a critical value.

20. The backlight module according to claim 18, wherein the voltage correction unit comprises a switching device configured to perform a switching operation in response to a correction control signal generated based on the dimming signal during a section in which the rectified voltage is less than or equal to a critical value, the switching device configured to connect an output terminal of the power factor correction unit to the backlight unit in response to the correction control signal.

21. The backlight module according to claim 20, wherein the voltage correction unit further comprises a diode having an anode connected in series to one side terminal of the switching device, an other side terminal of the switching device being connected to the output terminal of the power factor correction unit, a cathode of the diode being connected to a node to which an input terminal of the backlight unit and the power rectification unit are connected.

22. A method of driving a backlight module, the backlight module being driven by a backlight unit driver which drives a backlight unit comprising a plurality of light emitting diode (LED) groups, each LED group comprising at least one light emitting diode, to provide illumination to a display module, the method comprising:
rectifying alternating power to generate a rectified voltage;
correcting a power factor of the alternating power to generate a power factor-corrected voltage comprising a direct voltage component having at least a predetermined magnitude;
receiving the rectified voltage to generate a main drive voltage or a main drive current and supplying the main drive voltage or the main drive current to the backlight unit; and
supplying a supplementary drive voltage or a supplementary drive current based on the power factor-corrected voltage to the backlight unit when the rectified voltage is less than a preset critical value.

23. The method according to claim 22, wherein receiving the rectified voltage comprises controlling the backlight unit based on the rectified voltage, the magnitude of which periodically varies over time, such that the number of LED groups emitting light among the plurality of LED groups increases as the rectified voltage increases, and such that the number of LED groups emitting light among the plurality of LED groups decreases as the rectified voltage decreases.

24. The method according to claim 23, wherein supplying the supplementary drive voltage or the supplementary drive current comprises supplying the supplementary drive voltage or the supplementary drive current based on the power factor-corrected voltage to the plurality of LED groups, when the rectified voltage is less than a minimum voltage for driving at least one LED group among the plurality of LED groups.

25. The method according to claim 22, further comprising:
receiving a dimming signal from the display module to control the backlight unit driver to generate a preset dimming voltage or a preset dimming current, before supply of the supplementary drive voltage or the supplementary drive current,
wherein supplying the supplementary drive voltage or the supplementary drive current comprises supplying the supplementary drive voltage to the backlight unit when the main drive voltage is less than the preset dimming voltage, or supplying the supplementary drive current to the backlight unit when the main drive current is less than the preset dimming current.
